(19) United States
(12) Patent Application Publication
(10) Pub. No.: US 2025/0286310 A1
(43) Pub. Date: Sep. 11, 2025

(54) TEMPERATURE-CONTROLLABLE PLUG-IN CONNECTOR

(71) Applicant: HARTING ELECTRIC STIFTUNG & CO. KG, Espelkamp (DE)

(72) Inventors: Fabrizia GHEZZO, Espelkamp (DE); Christian CORDING, Espelkamp (DE)

(21) Appl. No.: 18/858,621

(22) PCT Filed: Apr. 3, 2023
(86) PCT No.: PCT/DE2023/100255

§ 371 Date: Oct. 21, 2024

(30) Foreign Application Priority Data
Apr. 22, 2022 (DE) 10 2022 109 760.9

(51) Int. Cl. H01R 13/533

(52) U.S. Cl. CPC H01R 13/533

(57) ABSTRACT

A plug-in connector for transmitting high electrical power is provided, which comprises at least one contact for transmitting the high electrical power and a housing for holding and isolating the at least one contact, wherein walls of the housing consist at least in part of a sandwich structure, allowing the through-passage of a medium for temperature control, and for this purpose the housing comprises at least one input port for the inlet of the medium and at least one output port for the outlet of the medium. With this measure, the temperature of the plug-in connector can be controlled in a desired temperature range, and internal and external influences on the temperature of the plug-in system can be compensated for.

### BACKGROUND

### Technical Field

The present disclosure relates to a plug-in connector for transmitting high electrical power which is easily, robustly, and actively temperature-controllable.

### Description of the Related Art

The present disclosure relates to plug-in connectors, for example, industrial high-power and/or high-voltage plug-in connectors or charging plug-in connectors for electric vehicles which have an expanded temperature range and increased safety.

In today's ever more industrialized world and with the emergence of the need for a greater proportion of renewable energy, such as, for example, from photovoltaics and wind power, electrical current is becoming more and more important as the most universal form of energy. It is increasingly replacing other, usually chemically bound forms of energy which are based on long-chain hydrocarbons.

Distribution grids are required for the distribution of the current over a wide area. Many of the current-consuming terminal devices are connected to the distribution grid via plug-in connectors. Especially in the industrial sector, high-power plug-in connector systems are often required today which are capable of transmitting high levels of energy. It is not uncommon for there to be several hundred amperes in a plug-in connection. Such plug-in connectors generally also have an exceptionally high insulating capacity of usually several thousand volts. The contacts of such plug-in connector systems are therefore subject to a high load and, despite a careful design with very low transition resistances, become very hot when under full load. This heat must be dissipated via the housing which therefore, on the one hand, must also have a robust design and often uses metal alloys as the material of the housing and, on the other hand, as already mentioned above, must be able to insulate high voltages, for which purposes plastics such as, for example, polyamide may be used. Plug-in connections which are exposed to the elements, such as, for example, plug-in connectors between two railroad cars of a train, must moreover be sealed so that no moisture reaches the sensitive contacts. Such plug-in connectors in the railroad sector in winter often suffer from icing which makes it impossible to disconnect the plug-in connection when reconfiguring a train.

In the medical sector, in data centers, in high-precision devices, etc., plug-in connectors which transmit current and data can overheat because of the low heat dissipation of the materials. This makes them problematic for any measuring devices situated in the vicinity or highly sensitive electronic parts because heat builds up after operation for a relatively long period of time.

Another aspect to be taken into consideration is the weight of conventional plug-in connectors (for example, high-voltage high-power plug-in connectors). In many sectors such as, for example, in the railroad industry, there is a need to reduce the weight of these plug-in connectors because of the requirements to save energy. The material of the plug-in connector generally consists, because of the requirements for robustness, of metal (for example, made from aluminum, nickel, metal alloys, etc.) which is a few mm thick (˜4 mm).

These housings are generally produced in a die casting process. For these applications, it would be advantageous to reduce the weight of the housing and to give the whole plug-in connector system greater versatility and further functions, wherein the robustness and the mechanical performance must not be compromised.

For such sectors, Applicant believes there is thus a need for plug-in connectors which have improved thermal management compared with known systems such that they can neither heat up easily nor freeze easily.

A search by the German Patent and Trademark Office has found the following prior art in the priority application for the present application: DE 10 2015 104 029 B3, DE 10 2012 102 275 A1, DE 10 2016 213 873 A1, DE 10 2017 122 662 A1, DE 10 2019 111 749 A1, CN 212 626 226 U, CN 105 099 548 A, and JP 2009-266418 A.

### BRIEF SUMMARY

Embodiments of the present invention provide an improved plug-in connector which no longer has the abovementioned problems and has a reduced weight with a similar robustness.

Embodiments of the invention make it possible to protect the internal modules of the plug-in connector from the outside environment in the case of exceptional temperature fluctuations (external heat or external cold). Conversely, the plug-in connector according to embodiments of the invention can also protect the environment from excessive heat which is generated by the contacts in the insulating body of the internal modules of the plug-in connector and is otherwise radiated to the outside through the housing.

The use of embodiments of the present invention here solves many problems. Thus, for example, the icing of plug-in connections between two railroad cars in railroad operations in winter can be prevented. Icing which does occur prevents the disconnection of such a plug-in connection. Active temperature control of the housing of the plug-in connector can thaw this icing and consequently make the plug-in connection disconnectable again.

An embodiment of a plug-in connector for transmitting high electrical power according to the present invention can be summarized as including at least one contact for transmitting the high electrical power, and a housing for retaining and insulating the at least one contact, wherein walls of the housing consist at least partially of a sandwich structure which enables the passage of a medium for the purpose of temperature control, and wherein the housing has at least one input port for the inlet of the medium and at least one output port for the outlet of the medium. This measure advantageously makes it possible for the housing to be actively temperature-controlled with a simultaneous reduction in weight and essentially the preservation of the mechanical properties such that the plug-in connector can be used in other areas, and is safer and lighter.

The term “high electrical power” includes below power with currents of several tens of amperes to several hundred amperes at voltages of several hundred to several thousand volts.

In a particularly advantageous embodiment of the plug-in connector, the medium is a gaseous medium. In particular when the medium is air, the sealing of the whole system is of less importance, which can advantageously save costs when producing the plug-in connector system.

In another embodiment, the medium is a liquid medium. Better heat transfer can advantageously be achieved in a closed circuit with a liquid such that particularly high requirements for the temperature control can advantageously be better met. Many different liquids can be considered as the liquid, for example, the cooling liquid for batteries produced by the company 3M. Any other suitable liquid can, however, also be used. It is important here that the liquid used is not corrosive and has a low freezing point, for example in the range from −10° C. to −50° C. Conventional glycol systems for motors fulfil this requirement, for example.

In an advantageous embodiment, the sandwich structure has an upper cover layer and a lower cover layer between which a core is arranged which has a structure which is suitable for allowing the medium to flow through it, wherein one of the cover layers is arranged on the outside of the housing and the other cover layer is arranged on the inside of the housing. This measure advantageously ensures a particularly efficient transmission of heat from the housing of the plug-in connector to the medium, reduces the weight of the housing with almost the same mechanical properties, and thus barely increases the mechanical dimensions of the housing or not at all.

In one embodiment, the core is an open-pore foam made from metal, a polymer, or a natural material. Such a core is advantageously simple to produce and very suitable in terms of heat transfer and heat flow.

In another embodiment, the core has a grid-like structure which can be configured as pyramidal, tetrahedral, or trihexagonal. Such housings can advantageously be produced either by investment casting or by means of an additive manufacturing process such that complex housing shapes can also be realized.

In another embodiment, the core has a woven or knitted structure, wherein the woven threads are made from metal, an artificial fiber, a natural fiber, or a mixture thereof. Weaving and knitting processes are particularly efficient and sophisticated technically such that the housing with such a core can be-produced particularly efficiently and cost-effectively.

In general, the sandwich structure can comprise or consist of many different material systems and the cover layers can be made from a different material than the core in order to meet specific requirements.

The materials from which the cover layers are made can be aluminum, steel, nickel, titanium, other metals, metal alloys, polymers, biocompatible polymers, self-healing polymers, shape-memory polymers, fiber-based materials (composite materials), ceramic-based materials, metal-reinforced polymers, ceramic, glass, carbon fibers/flakes/nanoparticles or selective combinations of the abovementioned materials.

The core materials can be selected from open-cell metal foams, open-cell metal alloy foams, open-cell polymer foams, open-cell foams made from natural materials (for example, cork), etc., but are not restricted thereto.

The channels in the core materials (polymers or metals or a combination thereof) can be of any desired shape. The system functions in a similar manner to blood vessels in a body. The distribution of the channels in the core material of the housing may be optimized depending on the distribution of the heat radiated by the contacts in the insulating body to the housing. The design of the network of such channels may depend on the shape of the housing, the size, and the location at which the maximum heat in the housing is reached.

A person skilled in the art who has been trained in technical mechanics and materials can design such a system in such a way that it corresponds to the requirements of the specific target application.

The sandwich structure can also comprise or consist of just one material which can be selected from the above materials. When using additive manufacturing processes, such as for example 3D printing, the cover layers and the core can be produced as a single piece. When using modern additive manufacturing processes, a change of materials in one and the same component can be designed and produced.

The whole structure can be configured as a sandwich structure (2 cover layers and a core) or as one cover layer which provides protection from the external environment, and a core (in this case, the inside of the core is not porous). This structure can be formed using the abovementioned materials and any desired combination of these materials which meet the mechanical/structural, thermal, impact-resistance, and other requirements.

In one embodiment, the input port and output port for temperature-controlling large parts of the housing are arranged on opposite sides of the housing. As a result, the medium flows through a majority of the housing, which advantageously has the consequence of particularly good heat transfer.

In a further embodiment, the output port comprises or consists of one or more apertures, through the cover layer on the outside of the housing, through which the gaseous medium can escape. This is advantageous in particular in the case of temperature control with air as the medium because the air, for example, compressed air, can escape again very simply at the apertures in the plug-in connection of a train and thus advantageously no complex circulation system needs to be established.

In a modified embodiment, the input port and the output port are arranged at the same level of the housing as the at least one electrical contact for the simultaneous production of the connection of the electrical contact and the medium. This measure advantageously ensures, when a closed circulation system is required, that the electrical connections and those of the medium are produced at the same time as the plug-in connector system is plugged in, which particularly simplifies the handling of such a system.

In an advantageous embodiment, the housing can be produced with an additive manufacturing process. Complex housing shapes and complex core geometries can thus advantageously also be readily and reliably produced.

The shape of the housing may be optimized for a faster heat transfer and a high structural strength for the respective application (trains, air and space travel, data centers, etc.) in which it is needed.

In one embodiment, a temperature-control system for temperature-controlling the medium is integrated into the plug-in connector. In particular in the case of large high-power plug-in systems, a particularly autonomous plug-in system can be implemented as a result.

In a modified embodiment, the temperature-control system for temperature-controlling the medium is arranged outside the plug-in connector. Especially in the case of smaller plug-in connectors or an installation with a large number of these plug-in connectors, this measure can advantageously be more efficient and more cost-effective. It is advantageous here if a temperature sensor is arranged in the housing which can inform the temperature-control system when the housing has to be temperature-controlled owing to an excessively high or excessively low temperature.

### BRIEF DESCRIPTION OF THE SEVERAL VIEWS OF THE DRAWINGS

Exemplary embodiments of the invention are illustrated in the drawings and are explained in detail below. In the drawings:

FIG. 1 shows on the left-hand side a first embodiment of a plug-in connector, the housing walls of which comprise or consist of a sandwich structure as is shown on the right-hand side,

FIG. 2 shows the same first embodiment of the plug-in connector on the left-hand side, wherein a medium for temperature-controlling the housing is channeled through the sandwich structure, as indicated on the right-hand side,

FIG. 3 shows a schematic illustration of the sandwich structure, comprising or consisting of a lower cover layer, an inner core, and an upper cover layer,

FIG. 4 shows a second embodiment of a plug-in connector which also has a housing, the walls of which are manufactured from a sandwich structure,

FIG. 5 shows a first view in section of the second embodiment of the plug-in connector with an inner honeycomb structure which has been made visible,

FIG. 6 shows a second view in section of the second embodiment of the plug-in connector with an inner honeycomb structure which has been made visible,

FIG. 7 shows the second view in section of the second embodiment of the plug-in connector with differently arranged input and output ports,

FIG. 8 shows a third embodiment of a plug-in connector with a housing comprising or consisting of a sandwich structure, wherein different possible sandwich structures are presented on the right-hand side.

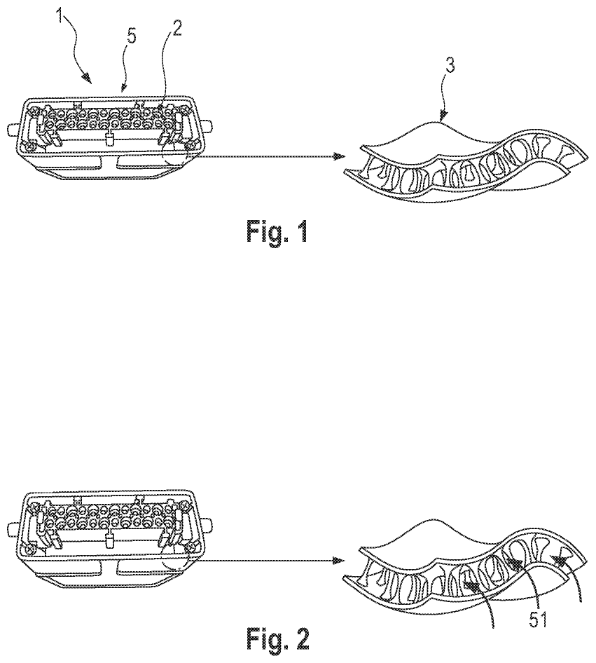

### DETAILED DESCRIPTION

The Figures may contain partially simplified schematic illustrations. Identical reference signs are used in part for the same but possibly non-identical elements. Different views of the same elements could be at different scales. Specified directions such as, for example, “left,” “right,” “up,” and “down” are to be understood with reference to the respective Figure and can vary with respect to the object illustrated in the individual illustrations.

FIG. 2 shows on the left-hand side a plug-in connector 1, the wall of which comprises or consists of a sandwich structure 3. Indicated on the right-hand side is that a medium 51 is channeled through the sandwich structure 3 in order to temperature-control the housing 5 of the plug-in connector. In the embodiment illustrated, the medium 51 is air which is channeled through the walls of the plug-in connector 1. For this purpose, the plug-in connector 1 has at least one input port (not shown here) for the inlet of the medium 51 into the interior of the sandwich structure 3 of the walls of the plug-in connector 1. So that the medium 51 can leave the plug-in connector again, the housing 5 also has at least one output port (also not shown here). When the medium 51 is air, for example, compressed air, the output port can simply be one or more holes in the wall of the housing 5, through which the air can escape again.

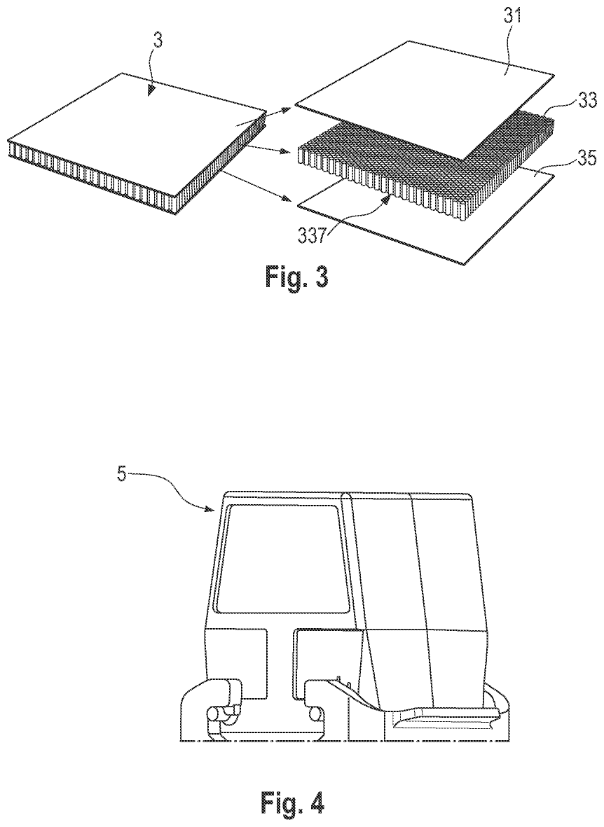

FIG. 3 shows an exemplary construction of a sandwich structure 3. The sandwich structure 3 comprises or consists of an upper cover layer 31 and a lower cover layer 35. Situated in between them is a core 33 which has a structure which allows the flow of a medium 51 through it. In FIG. 3, the core 33 has an open-pore honeycomb structure 337 in which the honeycomb walls have holes 339 for the passage of the medium 51. The structure of the core 33 can, however, also assume any other shape which is tailored specifically to the use case. The structure of the core 33 should only optimally guide the flow of the medium 51 through it such that it dissipates the temperature as efficiently as possible. At the same time, the sandwich structure 3 contributes to good mechanical robustness of the housing. The structure 33 can be, for example, an open-pore metal foam made from a suitable polymer or a natural material. The polymer or the natural material can include fillers for better temperature dissipation. The structure of the core can also be optimized for the respective use case by way of a suitable mathematical method such as, for example, finite element calculation. The definition of the structure can also be generated by way of algorithms with the above boundary conditions integrated into the algorithm.

A plug-in connector housing comprising or consisting of such a sandwich structure 3 has one of the two cover layers 31 or 35 on the inside of the housing of the plug-in connector and one of the cover layers 35 or 31 on the outside of the housing of the plug-in connector.

Input ports and output ports in each case pierce the cover layer 31 or 35 on the outside of the housing 5 of the plug-in connector such that the medium 51 passes into the core through the input port, is guided through the core, and leaves the core again at the output port. Advantageously, the input and output ports may be arranged on opposite sides of the housing 5 of the plug-in connector 1 such that the medium 51 flows through the largest possible area of the housing wall of the plug-in connector 1 in order to achieve optimal heat transfer between the medium 51 and the housing 5.

Depending on the application, the input and output ports can, however, also be arranged on the same side of the housing in order to facilitate a connection to a temperature-control system. The structure of the core must here be configured such that the medium 51 flows through the core as uniformly as possible.

The cover layers 31, 35 and the core 33 of the housing may be made here from the same material such that it is not possible for thermally induced detachment of the cover layers 31, 35 from the core 33 to occur. In such a configuration, the housing is advantageously produced by way of a suitable 3D printing method. Specifically in the case of more complex housing shapes with many curves, 3D printing is the advantageous method for producing the housing 5.

Depending on requirements, the core 33 can, however, also be made from a different material than the cover layers 31, 35. Materials with as similar as possible coefficients of thermal expansion are chosen here in order to prevent detachment of the cover layers 31, 35 from the core 33. Many combinations of materials are conceivable which can be tailored in each case to the specific use case of the plug-in connector.

The medium 51 can be a gaseous medium such as air, nitrogen, or the like. The medium 51 can, however, also be a liquid medium which is then circulated and temperature-controlled by means of an air-conditioning system. The coolant for cooling batteries from the company 3M can, for example, be particularly well suited for this purpose which prevents corrosion, is environmentally friendly, and has no volatile organic compounds.

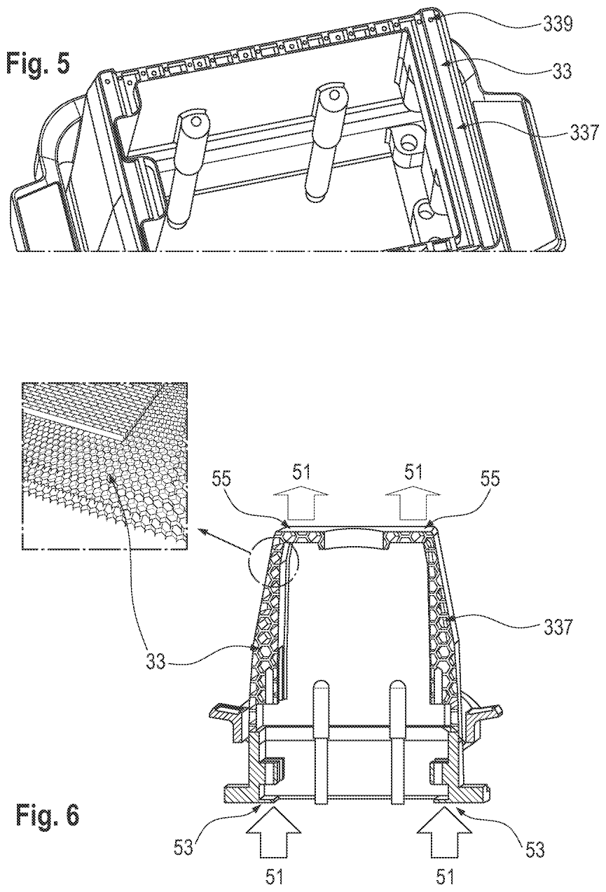

FIG. 4 shows a second embodiment of a plug-in connector 1 with a housing 5. Here too, the walls of the housing 5 comprise or consist of a sandwich structure 3 with a core 33 which is also designed here as a honeycomb structure 337 as shown in the view in section in FIG. 5. The honeycomb structure 337 of the core 33 is oriented in such a way that the medium can flow from one side of the housing 5—at the top in FIG. 5—to the other side of the housing 5—at the bottom in FIG. 5. So that the medium can expand in the core 33, the walls of the honeycomb structure 337 have holes 339 through which the medium 51 can pass from one honeycomb cell to the next.

FIG. 6 shows a second view in section with a plane of section rotated by 90°. Two input ports 53 which channel the medium 51 into the core 33 of the housing 5 are shown here. By virtue of the holes 339 shown in FIG. 5, the medium 51 can now be distributed over all the honeycomb cells and now flows along the honeycomb cells to the other side of the plug-in connector, where it can then escape again from the core 33 of the housing 5 at the outputs 55. Inputs 53 and outputs 55 may be advantageously situated diametrically opposite each other at the plug-in connector housing 5. This embodiment is particularly suitable for plug-in connections in the railroad sector, in which compressed air may be used as the medium for temperature control and is usually made available at the couplings of the train railroad cars. The compressed air does not have to be circulated and instead can simply escape at the output ports 55 at the top side of the plug-in connector. The output ports can in this case simply be apertures in the cover layer on the outside of the plug-in connector.

Depending on the housing shape and other requirements, the inputs and outputs can, however, also be arranged in a different way. The plug-in connector housing 5 can thus be temperature-controlled by the medium 51 and, depending on whether the medium is hotter or colder than the housing 5 of the plug-in connector 1, the housing 5 is heated or cooled.

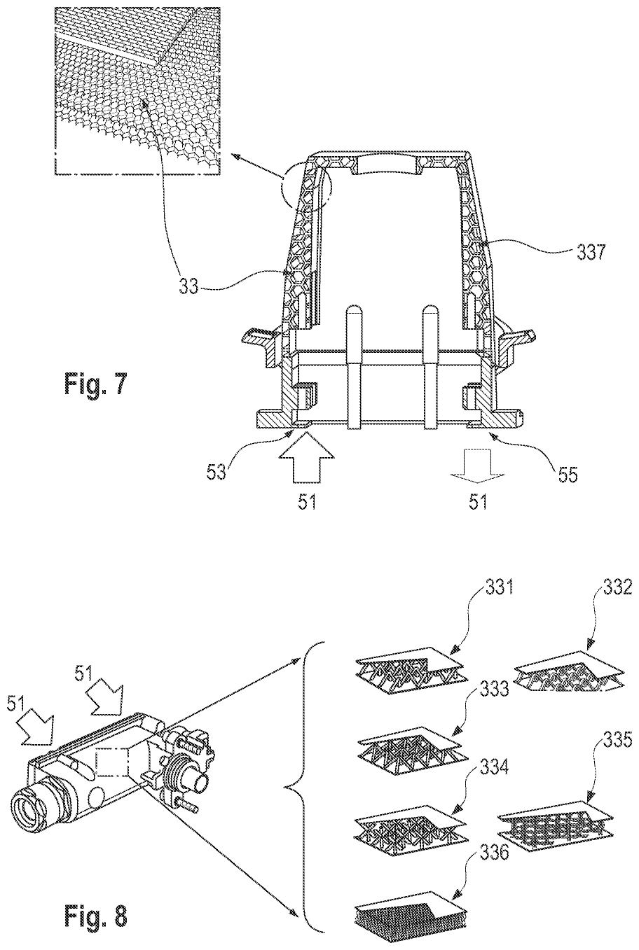

FIG. 7 shows the second view in section of FIG. 6 with differently arranged input and output ports 53, 55. The input port 53 is here arranged on the left-hand side of the contacting plane of the plug-in connector and the output port 55 is arranged on the right-hand side of the contacting plane. The contacting plane is the plane at the plug-in connector at which it is connected to its mating piece, i.e., the plane at which the two plug-in connectors are plugged together. This measure enables simple connection of the circulation of the medium 51 at the same time as the connection of the electrical contacts 2. All the necessary connections are therefore produced by plugging together the plug-in connector system, which simplifies the handling of the plug-in connector. The structure in the core 33 must here be designed such that the medium 51 preferably flows through the whole of the interior of the housing 5 before it escapes again in order to ensure good heat transfer. The structure of the core 33 should thus be divided in order to ensure that the medium 51 flows first through the first half of the housing 5 before it enters the second half and flows through the latter back to the output port 55.

The temperature-control system for the medium 51 can here be external but can also be integrated into the plug-in system. All conventional technical solutions for air conditioning, above all heat pump-based systems, can here be considered as temperature-control systems.

Lastly, FIG. 8 shows a third embodiment of a plug-in connector 1. This plug-in connector 1 is designed for high currents and voltages and can therefore get hot during operation. In order to be able to dissipate the heat, the known housing is also replaced here by a housing with a sandwich structure 3. On the right-hand side of FIG. 8, different types of specific sandwich structures 3 are shown with structures which have their own reference signs below. These sandwich structures 3 can be produced in different processes. The structure 331 is produced from metal in an investment casting process and has a tetrahedral structure as the core 33. The cover layers 31, 35 can be produced from different materials such as aluminum, steel, nickel, alloys, metal-filled plastics, or alternatively from composite materials with fiber composites. Natural materials and biologically obtained plastics are also conceivable. Ceramic materials can also be used.

The structure 332 also has a tetrahedral core 33 which is, however, not produced here in an investment casting process and instead from folded sheet metal.

The structure 333 has a pyramidal core 33 produced in an investment casting process.

The structure 334 has a trihexagonal core 33 likewise produced in an investment casting process. The trihexagonal core 33 can also be woven or knitted from metal wire, which results in the structure 335.

The structure 336 is woven or knitted from textile fibers. Textile fibers are known for allowing the flow of a gaseous medium through them such that such a structure is particularly suited in the case of a gaseous medium 51. The production processes for this are particularly sophisticated such that the production of a core 33 with such a structure 336 is very cost-effective.

In a particularly advantageous embodiment, the housing 5 with the sandwich structure 3 is produced in a 3D printing process, which enables complex geometries which cannot be produced with other processes. Especially when the structure of the core 33 is calculated and created using computer-assisted processes, this structure can be produced particularly simply with a 3D printer. In addition, the core 33 and the cover layers 31, 35 are produced here with a 3D printer from the same material and monolithically such that no detachment of the cover layers 31, 35 from the core 33 can occur.

All the established additive manufacturing processes such as SLS (selective laser sintering), FFF (fused filament fabrication), SL (stereolithography), SLM (selective laser melting), EBM (electron beam melting), and many other additive processes can be used to produce the housing 5.

Alternatively, the housing can, however, also be produced with conventional production processes such as injection molding, pressure die-casting, vacuum resin transfer molding, and conventional layering techniques such as GRP (glass fiber reinforced plastic). The housing 5 can here be preproduced in 2 halves which are then joined together.

Moreover, aspects of the various embodiments described above can be combined to provide further embodiments.

In general, in the following claims, the terms used should not be construed to limit the claims to the specific embodiments disclosed in the specification and the claims, but should be construed to include all possible embodiments along with the full scope of equivalents to which such claims are entitled.

1. A plug-in connector for transmitting high electrical power, comprising:
at least one contact for transmitting the high electrical power; and
a housing for retaining and insulating the at least one contact and/or a contact support which is provided for mounting the at least one contact,
wherein walls of the housing consist at least partially of a sandwich structure which enables the passage of a medium for the purpose of temperature control, and
wherein the housing has for this purpose at least one input port for the inlet of the medium and at least one output port for the outlet of the medium.

2. The plug-in connector as claimed in claim 1, wherein the medium is a gaseous medium.

3. The plug-in connector as claimed in claim 1, wherein the medium is a liquid medium.

4. The plug-in connector as claimed in claim 1, wherein the sandwich structure has an upper cover layer and a lower cover layer between which a core is arranged, wherein one of the upper and lower cover layers is arranged on an outside of the housing and the other one of the upper and lower cover layers is arranged on an inside of the housing.

5. The plug-in connector as claimed in claim 4, wherein the core is an open-pore foam made from metal, or a natural material.

6. The plug-in connector as claimed in claim 4, wherein the core has a grid-like structure which is configured as pyramidal, tetrahedral, or trihexagonal.

7. The plug-in connector as claimed in claim 4, wherein the core has a woven or knitted structure, and wherein woven threads of the woven or knitted structure are made from metal, an artificial fiber, a natural fiber, or a mixture thereof.

8. The plug-in connector as claimed in claim 4, wherein the core has a honeycomb structure, and wherein honeycomb cells of the honeycomb structure have openings at certain points in order to channel the medium.

9. The plug-in connector as claimed in claim 1, wherein the input port and output port are arranged on opposite sides of the housing.

10. The plug-in connector as claimed in claim 4, wherein the output port consists of one or more apertures, through the cover layer on the outside of the housing, through which the gaseous-medium can escape.

11. The plug-in connector as claimed in claim 1, wherein the input port and the output port are arranged at a same level of the housing as the at least one electrical contact for the simultaneous production of the connection of the electrical contact and the medium.

12. The plug-in connector as claimed in claim 1, wherein the housing is produced by an additive manufacturing process.

13. The plug-in connector as claimed in claim 1, wherein a temperature-control system for temperature-controlling the medium is integrated into the plug-in connector.

14. The plug-in connector as claimed in claim 1, wherein a temperature-control system for temperature-controlling the medium is arranged outside the plug-in connector.
